(19) United States
(12) Patent Application Publication
(10) Pub. No.: US 2005/0218356 A1
(43) Pub. Date: Oct. 6, 2005

(54) Device for protecting an image plate used in X-ray imaging

(76) Inventor: Esa Apajasaari, Vantaa (FI)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/094,777

(22) Filed: Mar. 30, 2005

(30) Foreign Application Priority Data
Mar. 30, 2004 (FI) 20045109

(51) Int. Cl. G03B 42/08

(52) U.S. Cl. 250/589; 250/584; 250/484.4

(57) ABSTRACT

The invention relates to a device (3) for protecting an image plate (2) used in X-ray imaging during various processes required by X-ray imaging and reading (1) of a radiographed image plate, said image plate comprising an active surface provided with a material activated in response to X-radiation, and a rearward surface. The device comprises a protection element (3) extending over the entire active surface of the image plate (2), and which is adaptable to also extend at least partially over the rearward surface of the image plate.

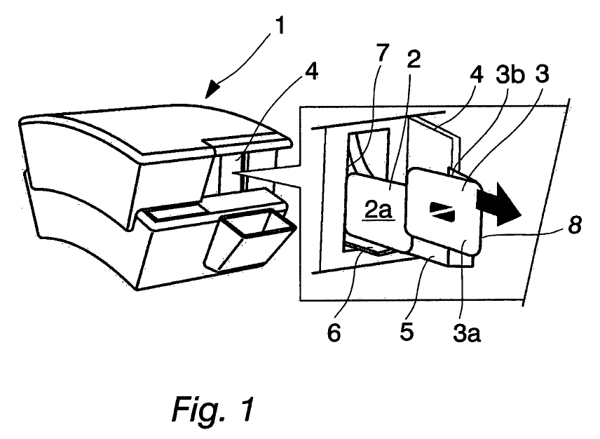

The invention relates to a device for protecting an image plate used in X-ray imaging without a cassette during various processes required by X-ray imaging and reading of a radiographed image plate, said image plate comprising an active surface provided with a material activated in response to X-radiation, and a rearward surface. In particular, the invention relates to a protection device for an image plate used in intraoral X-ray imaging.

An image plate (IP) for use in digital X-ray imaging comprises normally a plate resembling an intensifying screen, having its active surface provided with crystals activated (excited) in response to X-radiation. Excitation results in a latent image to form on the image plate. The state of excitation is discharged by means of a laser beam, whereby the image plate releases energy in the form of photons. The photons are passed by way of a photomultiplier duct to an AD-converter, in which light is converted into digital electric signals to be reconstructed for an image on a computer screen. Reading is followed by having the visual information left on the image plate erased by means of powerful light for reusing the vacated image plate without a noise caused by prior imaging processes. A digital X-ray imaging system comprises image plates, a reading apparatus for image plates, and a workstation with its display units. U.S. Pat. No. 6,528,813 describes one image-plate using system, in which the image plate is held within a cassette case during X-ray imaging and passage to a reading apparatus. Descriptions of image plate can be found e.g. in publications U.S. Pat. No. 4,236,078 and U.S. Pat. No. 4,239,968.

The image plate used in intraoral X-ray imaging is normally kept in a protective sleeve and placed for the duration of X-ray imaging in the mouth of a person being radiographed, which involves a risk of scratching or damaging the image plate on its active side by teeth, for example a dental crown, e.g. as a result of accidental biting. Removing an image plate from a protective sleeve presents a risk of soiling the image plate with possibly dirty hands or gloves. A further hazard is a premature deletion of visual data stored on the image plate as a result of ambient light, e.g. when the image plate is passed from a protective sleeve to an image reader.

Accordingly, the present invention has an objective of providing a solution capable of eliminating the foregoing problems. This objective is accomplished by providing a protection device for protecting an image plate used in X-ray imaging during X-ray imaging and passage to a reading apparatus, said device being characterized in that the device comprises a protection element extending over the entire active surface of the image plate, and which is adaptable to also extend at least partially over the rearward surface of the image plate.

The protection element is preferably made of cardboard, plastics or any other material which does not absorb X-radiation in a manner affecting image quality and which itself does not scratch or soil the image plate. The protection element is preferably provided with a folding line, by means of which a part of the protection element is foldable to extend also over a rearward surface of the image plate or a portion thereof.

The invention will now be described in more detail with reference to the accompanying drawing, its sole figure depicting, in a perspective schematic view, a reading apparatus for the image plate, and in an enlarged fragmentary view, the image plate equipped with a protection element of the invention on its way to the reading apparatus.

A reading apparatus 1 houses an image-plate reading unit and an erasing unit for erasing residual radiation of the image plate after reading the image. The reading apparatus 1 is provided with a door 4, behind which is an enter slot 7 for the image plate. An image plate 2 to be inserted in the reading apparatus 1 is set against support members 5, 6 emerging from the slot 7 as the cover 4 is opened. Then, the support members 5, 6 are passed, along with the image plate, into the reading apparatus and the cover 4 closes. The support members are preferably provided with magnet elements grabbing the image plate by its edge, whereafter a protection element 3 can be removed from its position on top of the image plate. The presently exemplified protection element 3 is provided with a folding 8, dividing the protection in two segments 3a and 3b, such that the larger segment 3a covers the image plate 2 essentially all across its active surface 2a and the smaller segment 3b extends at least partially over a rearward surface of the image plate.

The protection is simply placed on top of the image plate 2 and is held stationary in various processes by having the protection and image plate pressed between the user's fingers. The protection element 3 can be used in various phases of handling the image plate, e.g. in the process of inserting the image plate in the mouth for X-ray imaging and in the process of removing the image plate from a protective sleeve for passing it to the reading apparatus for reading the image plate. Another conceivable protection design is such that the protection remains stationary all the time without having to press it between the fingers. In addition, by designing a protection element from a waterproof material, which is sealingly placed on top of an image plate to protect the image plate from moisture and soiling, the protection element may eliminate the use of a separate protective sleeve. In this particular embodiment, a protection element could be applied on top of an image plate in the manufacturing process, and a new protection element again after the image plate has been erased, e.g. by means of an attachment included in the reading apparatus. In this case, the reading apparatus could be provided with means for opening the protection element automatically as the image plate is passed to the reading apparatus. Keeping the protection element stationary could be organised e.g. by means of snap coupling elements, capable of locking the segments 3a and 3b to each other.

Instead of magnet elements grabbing an image plate by its edge, the reading apparatus may only be provided with a take-up slot, e.g. in a top portion of the apparatus, in which an image plate can be simply dropped gravitationally from within a protection element by releasing a pressure applied to the protection element with fingers or by unlocking the protection element coupling means. The image plate take-up slot is preferably designed in such a way that the image plate is dropped in a substantially vertical position into the reading apparatus, although the image plate can be passed in some other position into the reading apparatus, assisted by gravity. It is also conceivable to employ various mechanical elements for taking hold of an image plate during its passage to a reading apparatus.

1. A device (3) for protecting an image plate (2) used in X-ray imaging during various processes required by X-ray imaging and reading (1) of a radiographed image plate, said image plate comprising an active surface provided with a material activated in response to X-radiation, and a rearward surface, characterized in that the device comprises a protection element (3) extending over the entire active surface of the image plate (2), and which is adaptable to also extend at least partially over the rearward surface of the image plate.

2. A device as set forth in claim 1, characterized in that the protection element (3) is made of cardboard, plastics or any other material which does not absorb X-radiation from the standpoint of image quality.

3. A device as set forth in claim 1, characterized in that the protection element (3) is made of a waterproof material, providing a high-seal barrier on the image plate against moisture and dirt.

4. A reading apparatus (1) for image plates used in X-ray imaging, comprising elements for converting visual information compiled on the image plate into digital signals which are reconstructible for an image on a computer screen, characterized in that the reading apparatus includes elements for receiving the image plate (2) from within the protection element (3).

5. A reading apparatus as set forth in claim 4, characterized in that in association with the receiving elements are provided members for allowing a removal of the protection element (3) from its position on top of the image plate for taking a grip of the image plate (2).

6. A reading apparatus as set forth in claim 5, characterized in that the gripping members comprise magnet elements, grabbing the image plate (2) by its edge.

7. A reading apparatus as set forth in claim 4, characterized in that the receiving elements include a take-up slot set in a top portion of the reading apparatus for dropping the image plate gravitationally therein.
